(19) United States
(12) Patent Application Publication
(10) Pub. No.: US 2014/0244376 A1
(43) Pub. Date: Aug. 28, 2014

(54) SYSTEM AND METHOD FOR FACILITATING OFF-PEAK SALES USING A PAYMENT CARD NETWORK

(71) Applicant: MASTERCARD INTERNATIONAL INCORPORATED, Purchase, NY (US)

(72) Inventor: David WALL, Drogheda (IE)

(73) Assignee: MasterCard International Incorporated, Purchase, NY (US)

(21) Appl. No.: 13/774,116

(22) Filed: Feb. 22, 2013

(51) Int. Cl. G06Q 30/02

(52) U.S. Cl. CPC G06Q 30/0235
USPC 705/14.35

(57) ABSTRACT

A method for processing a discount for an off-peak transaction includes: receiving an off-peak offer, the offer including a merchant identifier, start time, end time, and transaction modifier; identifying an offer identifier; storing the offer with offer identifier; transmitting the stored offer; receiving a discount request, the request including a consumer identifier and offer identification; identifying a selected offer where the offer identifier matches the offer identification; receiving an authorization request including a consumer identification, merchant identification, transaction time, and transaction amount; calculating a new amount based on the transaction amount and the transaction modifier for the selected offer if the consumer identification matches the consumer identifier, the merchant identification matches the merchant identifier, and the transaction time is within the start and end times; and transmitting an authorization response for the new amount, where the response is for a final authorization rather than a partial authorization.

### FIELD

The present disclosure relates to the facilitating of off-peak sales using a payment card network, specifically the processing of an offer, coupon, or discount applied to a transaction initiated at an off-peak time specified by the merchant to encourage off-peak sales by consumers.

### BACKGROUND

In recent times, coupons, deals, offers, and other discounts have become a large part of marketing efforts by merchants. Generally, these discounts have been used in an attempt to entice consumers to shop with the merchant, with the merchant's goal being to increase sales, gain new customers, and encourage repeat business from existing customers. However, despite the success of such discount programs, consumers still tend to transact at specific times more often than others for many merchants. This results in a lull in business—an off-peak period, where the merchant may still have operating costs reflective of peak periods or periods having heavier volume but not be bringing in the same revenue as during those periods.

Therefore, there is a need for merchants to be able to provide discounts to consumers during off-peak periods in order to gain an increase in sales during those periods, particularly in ways that draw customers to do business at off-peak times. However, many merchants may be unequipped to provide discounts at specific times using their existing systems. Many point-of-sale devices and other transaction systems may not be equipped to process a discount only during specific times and not others, and may also not be equipped to do so for only specific days of the week. In addition, manual processing of such discounts at off-peak times by personnel may take time, which may increase the length of a transaction, which may discourage a consumer from transacting during an off-peak period again.

Thus, there is a need for a technical solution to process discounts for off-peak transactions that can be performed using legacy point-of-sale systems by leveraging existing payment processing networks.

### SUMMARY

The present disclosure provides a description of a systems and methods for processing discounts for off-peak transactions.

A method for processing a discount for an off-peak transaction includes: receiving, by a receiving device, at least one off-peak offer, wherein each off-peak offer includes at least a merchant identifier, a start time, an end time, and a transaction modifier; identifying, for each off-peak offer, an offer identifier; storing, in an offer database, the at least one off-peak offer, wherein each stored off-peak offer further includes the corresponding identified offer identifier; transmitting, by a transmitting device, at least one stored off-peak offer; receiving, by the receiving device, a discount request, wherein the discount request includes at least a consumer identifier and an offer identification; identifying, in the offer database, a selected off-peak offer, wherein the included offer identifier corresponds to the offer identification; receiving, by the receiving device, an authorization request for a financial transaction, wherein the authorization request includes at least a consumer identification, a merchant identification, a transaction time, and a transaction amount; calculating, by a processing device, a new transaction amount based on the transaction amount and the transaction modifier for the selected off-peak offer if the consumer identification corresponds to the received consumer identifier, if the merchant identification corresponds to the included merchant identifier, and if the transaction time is within the included start time and end time; and transmitting, by the transmitting device, an authorization response for the financial transaction, wherein the authorization response is for the new transaction amount, and wherein the authorization response is indicated as being for a final authorization rather than a partial authorization.

Another method for processing a discount for an off-peak transaction includes: receiving, by a receiving device, at least one off-peak offer, wherein each off-peak offer includes at least a merchant identifier, a start time, an end time, and a transaction modifier; identifying, for each off-peak offer, an offer identifier; storing, in an offer database, the at least one off-peak offer, wherein each stored off-peak offer further includes the corresponding identified offer identifier; transmitting, by a transmitting device, at least one stored off-peak offer; receiving, by the receiving device, a discount request, wherein the discount request includes at least a consumer identifier and an offer identification; identifying, in the offer database, a selected off-peak offer, wherein the included offer identifier corresponds to the offer identification; receiving, by the receiving device, an authorization request for a financial transaction, wherein the authorization request includes at least a consumer identification, a merchant identification, a transaction time, and a transaction amount; calculating, by a processing device, a chargeback amount based on the transaction amount and the transaction modifier for the selected off-peak offer if the consumer identification corresponds to the received consumer identifier, if the merchant identification corresponds to the included merchant identifier, and if the transaction time is within the included start time and end time; transmitting, by the transmitting device, an authorization response for the financial transaction; and processing, by the processing device, a chargeback, wherein the chargeback is for the calculated chargeback amount.

A system for processing a discount for an off-peak transaction includes a receiving device, a processing device, an offer database, and a transmitting device. The receiving device is configured to receive at least one off-peak offer, wherein each off-peak offer includes at least a merchant identifier, a start time, an end time, and a transaction modifier. The processing device is configured to identify, for each off-peak offer, an offer identifier. The offer database is configured to store the at least one off-peak offer, wherein each stored off-peak offer further includes the corresponding identified offer identifier. The transmitting device is configured to transmit at least one stored off-peak offer. The receiving device is further configured to receive a discount request, wherein the discount request includes at least a consumer identifier and an offer identification. The processing device is further configured to identify, in the offer database, a selected off-peak offer, wherein the included offer identifier corresponds to the offer identification. The receiving device is further configured to receive an authorization request for a financial transaction, wherein the authorization request includes at least a consumer identification, a merchant identification, a transaction time, and a transaction amount. The processing device is further configured to calculate a new transaction amount based on the transaction amount and the transaction modifier for the selected off-peak offer if the consumer identification corresponds to the received consumer identifier, if the merchant identification corresponds to the included merchant identifier, and if the transaction time is within the included start time and end time. The transmitting device is further configured to transmit an authorization response for the financial transaction, wherein the authorization response is for the new transaction amount, and wherein the authorization response is indicated as being for a final authorization rather than a partial authorization.

A processing device configured to process a discount for an off-peak transaction is configured to: identify, for at least one off-peak offer, an offer identifier, wherein each of the at least one off-peak offer includes at least a merchant identifier, a start time, an end time, and a transaction modifier; store, in a database, the at least one off-peak offer and corresponding offer identifier; identify, in the database, a selected off-peak offer based on an offer identifier included in a discount request; and calculate a new transaction amount for a financial transaction based on a transaction amount included in an authorization request for the financial transaction and the transaction modifier of the selected off-peak offer, wherein the authorization request further includes at least the merchant identifier and a transaction time included within the start time and end time of the selected off-peak offer.

A receiving device for use in process a discount for an off-peak transaction is configured to: receive at least one off-peak offer, wherein each of the at least one off-peak offer includes at least a merchant identifier, a start time, an end time, and a transaction modifier; receiving a discount request for use in identifying a selected off-peak offer, wherein the discount request includes at least a consumer identifier and an offer identifier used to identify the selected off-peak offer; and receive an authorization request for a financial transaction, wherein the authorization request includes at least a consumer identification, a merchant identification, a transaction time, and a transaction amount, wherein the transaction amount is used to calculate a new transaction amount based on the transaction modifier of the selected off-peak offer if the consumer identification corresponds to the consumer identifier, if the merchant identification corresponds to the merchant identifier, and the transaction time is within the included start time and end time.

Another system for processing a discount for an off-peak transaction includes a receiving device, a processing device, an offer database, and a transmitting device. The receiving device is configured to receive at least one off-peak offer, wherein each off-peak offer includes at least a merchant identifier, a start time, an end time, and a transaction modifier. The processing device is configured to identify, for each off-peak offer, an offer identifier. The offer database is configured to store the at least one off-peak offer, wherein each stored off-peak offer further includes the corresponding identified offer identifier. The transmitting device is configured to transmit at least one stored off-peak offer. The receiving device is further configured to receive a discount request, wherein the discount request includes at least a consumer identifier and an offer identification. The processing device is further configured to identify, in the offer database, a selected off-peak offer, wherein the included offer identifier corresponds to the offer identification. The receiving device is further configured to receive an authorization request for a financial transaction, wherein the authorization request includes at least a consumer identification, a merchant identification, a transaction time, and a transaction amount. The processing device is further configured to calculate a chargeback amount based on the transaction amount and the transaction modifier for the selected off-peak offer if the consumer identification corresponds to the received consumer identifier, if the merchant identification corresponds to the included merchant identifier, and if the transaction time is within the included start time and end time. The transmitting device is further configured to transmit an authorization response for the financial transaction; and processing, by the processing device, a chargeback, wherein the chargeback is for the calculated chargeback amount.

Another processing device configured to process a discount for an off-peak transaction is configured to: identify, for at least one off-peak offer, an offer identifier, wherein each of the at least one off-peak offer includes at least a merchant identifier, a start time, an end time, and a transaction modifier; store, in a database, the at least one off-peak offer and corresponding offer identifier; identify, in the database, a selected off-peak offer based on an offer identifier included in a discount request; calculate a chargeback amount for a financial transaction based on a transaction amount included in an authorization request for the financial transaction and the transaction modifier of the selected off-peak offer, wherein the authorization request further includes at least the merchant identifier and a transaction time included within the start time and end time of the selected off-peak offer; and process a chargeback, wherein the chargeback is for the calculated chargeback amount.

Another receiving device for use in process a discount for an off-peak transaction is configured to: receive at least one off-peak offer, wherein each of the at least one off-peak offer includes at least a merchant identifier, a start time, an end time, and a transaction modifier; receiving a discount request for use in identifying a selected off-peak offer, wherein the discount request includes at least a consumer identifier and an offer identifier used to identify the selected off-peak offer; and receive an authorization request for a financial transaction, wherein the authorization request includes at least a consumer identification, a merchant identification, a transaction time, and a transaction amount, wherein the transaction amount is used to calculate a chargeback amount based on the transaction modifier of the selected off-peak offer if the consumer identification corresponds to the consumer identifier, if the merchant identification corresponds to the merchant identifier, and the transaction time is within the included start time and end time.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a diagram illustrating a system for the processing discounts for off-peak transactions in accordance with exemplary embodiments.

FIG. 2 is a diagram illustrating a processing server for use in the system of FIG. 1 in accordance with exemplary embodiments.

FIG. 3 is a diagram illustrating an offer database of the processing server of FIG. 2 in accordance with exemplary embodiments.

FIGS. 4A and 4B are a processing flow illustrating the real-time processing of a discount for an off-peak transaction in accordance with exemplary embodiments.

FIGS. 5A and 5B are diagrams illustrating a graphical user interface for a merchant to configure off-peak discounts in accordance with exemplary embodiments.

FIGS. 6A-6C are diagrams illustrating a graphical user interface for a consumer to view and select available off-peak discounts in accordance with exemplary embodiments.

FIGS. 7 and 8 are flow charts illustrating exemplary methods for processing discounts for an off-peak transaction in accordance with exemplary embodiments.

FIG. 9 is a block diagram illustrating system architecture of a computer system in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard® and VISA®.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Processing a Discount for an Off-Peak Transaction

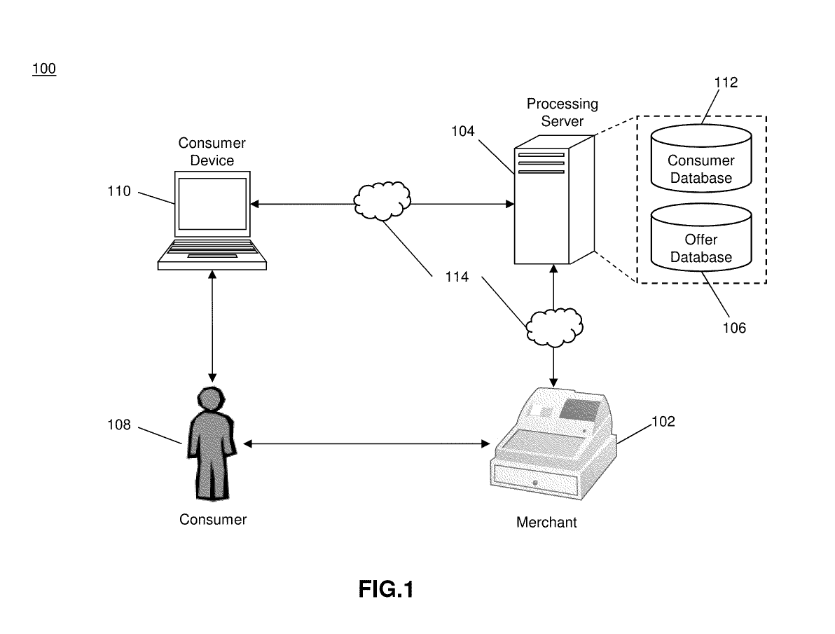

FIG. 1 is a block diagram illustrating a system 100 for processing a discount for an off-peak transaction in accordance with exemplary embodiments.

The system 100 may include a merchant 102. The merchant 102 may communicate with a processing server 104 to establish off-peak discounts via a network 114. The network 114 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The processing server 104 may be part of a payment network configured to process financial transactions.

In some embodiments, the merchant 102 may configure off-peak discounts via a webpage, discussed in more detail below, which may be hosted by the processing server 104 or a web hosting server operated by or on behalf of the processing server 104. In other embodiments, the merchant 102 may use an application program provided by the processing server 104 or may correspond with the processing server 104 (e.g., via telephone, email, etc.) to establish off-peak discounts. The processing server 104 may store the discount information as data included in an offer database 106, discussed in more detail below.

The off-peak discounts may be available for viewing and/or selection to a consumer 108. The consumer 108 may use a consumer device 110, such as a desktop computer, laptop computer, notebook computer, tablet computer, smart phone, cellular phone, etc. to view off-peak discounts available and stored in the offer database 106 of the processing server 104. Methods for viewing available offers will be apparent to persons having skill in the relevant art and may include using an application program executed by the consumer device 110, viewing a physical or electronic (e.g., via the consumer device 110) catalog of available offers, or accessing a webpage configured to enable the consumer 108 to view and/or select off-peak discounts as discussed in more detail below. The webpage may be hosted by the processing server 104 or by a web hosting server operated by or on behalf of the processing server 104.

In some embodiments, the consumer 108 may be required to register with a discount service and/or may be required to select off-peak discounts prior to redeeming them as part of an off-peak transaction. In such an embodiment where the consumer 108 must register, the consumer 108 may register with the processing server 104 using the consumer device 110 (e.g., via an application program or webpage). The processing server 104 may receive the consumer information and may store a consumer data entry including the consumer information as data related to the consumer 108 in a consumer database 112. In embodiments where the consumer 108 must select discounts prior to their use in an off-peak transaction, the consumer 108 may select desired discounts (e.g., via the application program or webpage), and the processing server 104 may store an association of the consumer 108 and the selected discounts as data in the consumer database 112.

The consumer 108 may then transact with the merchant 102 during an off-peak time during which a discount may be redeemable. The merchant 102 may submit an authorization request for a financial transaction to the processing server 104 using methods that will be apparent to persons having skill in the relevant art. In some embodiments, the authorization request may include information identifying the consumer 108. The processing server 104 may identify the available discount or discounts and may, in some embodiments, apply them to the financial transaction as part of the transaction processing or may, in other embodiments, may apply discounts following the processing of the transaction. Methods for applying a discount during or post-transaction processing are discussed in more detail below.

The processing server 104 may submit an authorization response to the merchant 102 following the processing of the financial transaction. The merchant 102 may then finalize the transaction, such as by furnishing the transacted goods or services to the consumer 108 or providing a receipt for the transaction to the consumer 108. In some embodiments, the processing server 104 may transmit a notification to the consumer 108 (e.g., via the consumer device 110) indicating the redemption of a discount for the financial transaction.

### Processing Server

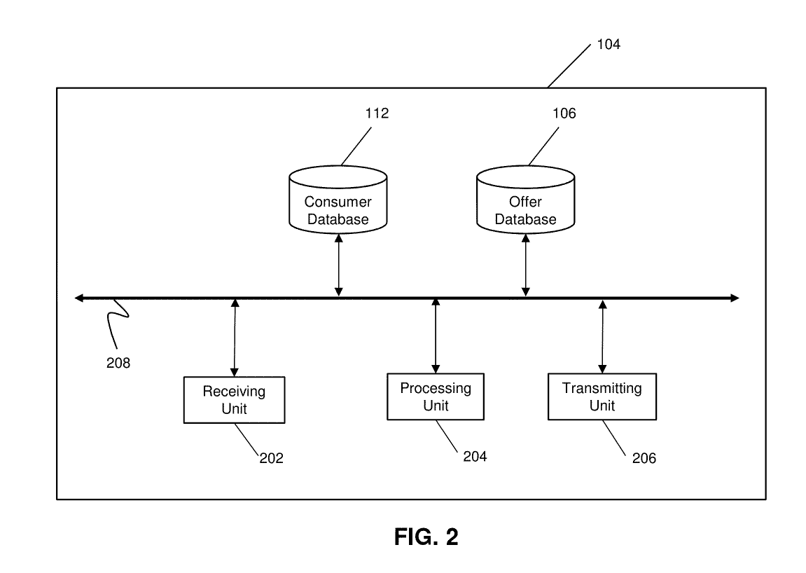

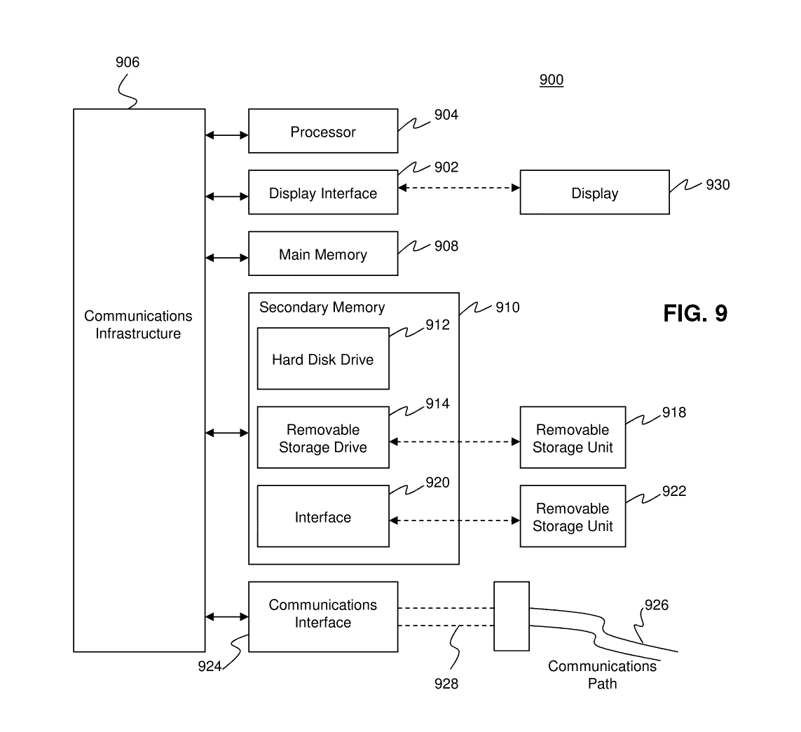

FIG. 2 illustrates an embodiment of the processing server 104 for use in the system 100. It will be apparent to persons having skill in the relevant art that the embodiment of the processing server 104 illustrated in FIG. 2 is provided as illustration only and may not be exhaustive to all possible configurations of the processing server 104 suitable for performing the functions as discussed herein. For example, the computer system 900 illustrated in FIG. 9 and discussed in more detail below may be a suitable configuration of the processing server 104.

The processing server 104 may include at least the consumer database 112, the offer database 106, a receiving unit 202, a processing unit 204, and a transmitting unit 206. Each of the components may be configured to communicate via a bus 208. Suitable types and configurations of the bus 208 will be apparent to persons having skill in the relevant art.

The consumer database 112 may be configured to store a plurality of consumer data entries, which may include data related to a plurality of consumers (e.g., the consumer 108). Information included in each consumer data entry may be dependent on the specific consumer and the application of the consumer database 112 as part of the system 100. For example, if the consumer 108 is required to register for the discount service in order to receive discounts for off-peak transactions, then the corresponding consumer data entry may include at least a consumer identifier an authentication information. The consumer identifier may be a unique value suitable for identifying the consumer 108, such as a username, phone number, e-mail address, payment card number, or financial account number or combinations thereof. The authentication information may be information suitable for authenticating the consumer 108, such as a password, security questions, etc.

If the consumer 108 is required to select discounts prior to being able to redeem the discount during an off-peak transaction, then each consumer data entry may at least the consumer identifier and at least one offer identifier. The offer identifier, discussed in more detail below, may be a unique value suitable for identifying the offer or discount to be redeemed in the off-peak transaction. Each consumer data entry may include additional data as will be apparent to persons having skill in the relevant art, such as merchant category preferences, discount preferences, redemption notification preferences, preferred method of communication, notification of new discount preferences, demographic information, advertising preferences, etc.

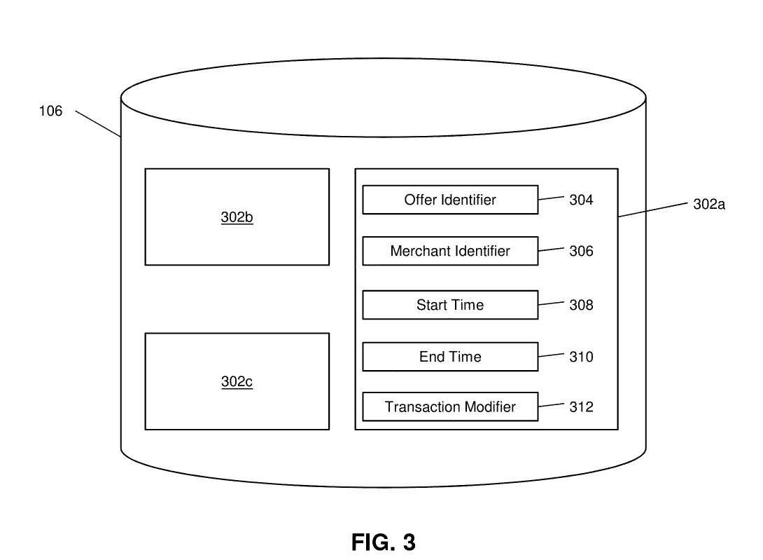

The offer database 106 may be configured to store a plurality of offer data entries, which may include data related to offers or discounts. The data included in each offer data entry may include at least an offer identifier uniquely identifying the related offer, and additional information discussed in more detail below with respect to FIG. 3. In some embodiments, the processing server 104 may further include a merchant database, which may be configured to store authentication data related to a merchant (e.g., the merchant 102). The merchant database may be used to identify a merchant based on provided authentication data via a webpage or application program, which may be used to associate received offer data information with the corresponding merchant.

Data stored in the offer database 106 and the consumer database 112 (the “databases”) may be stored on any type of suitable computer readable media, such as optical storage (e.g., a compact disc, digital versatile disc, Blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 114).

The receiving unit 202 may be configured to receive offer information for at least one off-peak discount from the merchant 102. The processing unit 204 may store the received offer information in corresponding offer data entries in the offer database 106. The receiving unit 202 may be further configured to receive registration information from the consumer 108 as part of the registration for the discount service. The processing unit 204 may store the received registration information in a consumer data entry in the consumer database 112 related to the consumer 108.

The receiving unit 202 may also be configured to receive an indication of at least one discount to be associated with the consumer 108 for redemption in a future off-peak transaction. The processing unit 204 may store, in the consumer data entry in the consumer database 112 related to the consumer 108, at least the offer identifier corresponding to each indicated discount.

The receiving unit 202 may be further configured to receive an authorization request for a financial transaction involving the consumer 108 and the merchant 102. The authorization request may include information suitable for identifying the consumer 108 and eligible discounts in the offer database 106, discussed in more detail below. The processing unit 204 may process the financial transaction using methods discussed herein, and the transmitting unit 206 may transmit an authorization response to the merchant 102 indicating the results of the processing of the financial transaction (e.g., whether the transaction has been approved or denied). The transmitting unit 206 may also transmit, to the consumer 108 and/or the consumer device 110, a notification of redemption if at least one discount was redeemed in the processing of the financial transaction. In one embodiment, the notification may be transmitted by a preferred method of distribution based on notification preferences as indicated in the consumer data entry related to the consumer 108 in the consumer database 112.

In some embodiments, the processing server 104 may further include a web hosting unit. The web hosting unit may be configured to store web page data and host the corresponding webpages for access by the consumer 108 and the merchant 102. Suitable methods for storing and hosting webpages will be apparent to persons having skill in the relevant art. In other embodiments, the receiving unit 202 and the transmitting unit 206 may be configured to communicate with a web hosting server (e.g., via the network 114) operated by or on behalf of the processing server 104.

### Offer Database

FIG. 3 is an illustration of the offer database 106 included in the processing server 104 for the storage of data related to offers and discounts to be applied to off-peak transactions.

The offer database 106 may include a plurality of offer data entries 302, illustrated in FIG. 3 as offer data entries 302a, 302b, and 302c. Each offer data entry 302 may include data related to an offer or discount to be redeemed during an off-peak transaction involving the merchant 102. Each offer data entry 302 may include at least an offer identifier 304, a merchant identifier 306, a start time 308, and end time 310, and a transaction modifier 312.

The offer identifier 304 may be a unique value suitable or identifying the offer data entry 302. Values that may be suitable for use as the offer identifier 304 will be apparent to persons having skill in the relevant art and may include a Universal Product Code (UPC), European Article Number (EAN), serial number, etc. The merchant identifier 306 may be a unique value suitable for identifying a merchant (e.g., the merchant 102) associated with the related discount or offer. The merchant identifier 306 may be used to identify offer data entries 302 as being applicable to a financial transaction involving the corresponding merchant 108. In one embodiment, the merchant identifier 306 may be a merchant identification number (MID).

The start time 308 may be a time at which the related offer or discount will be available to consumers. The end time 310 may by the time at which the related offer or discount is no longer available to consumers. In some embodiments, the offer data entry 302 may further include data indicating dates during which the related offer or discount may be available, in place of or in addition to start time 308 and end time 310. The dates may be days of the week, months, specific days in a calendar year (e.g., Black Friday), or any other type of date that will be apparent to persons having skill in the relevant art. For example, the start time 308, end time 310, and additional date information may indicate an offer available for an off-peak transaction occurring between 9:00 am and 10:00 am every day, a transaction between 10:00 am and 12:00 pm every weekday, a transaction any time on every Tuesday, etc.

The transaction modifier 312 may be data indicating how the transaction amount for a financial transaction is to be modified based on the redemption of the related offer or discount. For example, the transaction modifier 312 may indicate that the related discount is for $5 off of a transaction total, 10% off of a transaction total, a free specific product, a buy one get one free offer, etc. Suitable methods for indicating how a transaction is to be modified based on an offer will be apparent to persons having skill in the relevant art. Each offer data entry 302 may further include additional information as will be apparent to persons having skill in the relevant art, such as an offer name, an offer description, a minimum transaction amount, an offer quantity, an offer category, a merchant category, terms and conditions, a redemption frequency, expiration date, etc.

In some embodiments, the offer data entry 302 may include an indication of at least one consumer (e.g., the consumer 108) for which the related offer is to be redeemed. For example, the offer data entry 302 may include at least one consumer identifier corresponding to a consumer, which may be used in identifying the related offer for redemption. In some embodiments, each offer data entry 302 may include multiple consumer identifiers. In other embodiments, each offer data entry 302 may include a single consumer identifier, where multiple offer data entries 302 may include common offer identifiers 304 with unique offer identifier 304 and consumer identifier combinations. In one embodiment, the consumer identifier may be a payment card number, such that the offer data entry 302 may be identified if the corresponding payment card is involved in the financial transaction.

### Processing Flow for Processing a Discount for an Off-Peak Transaction

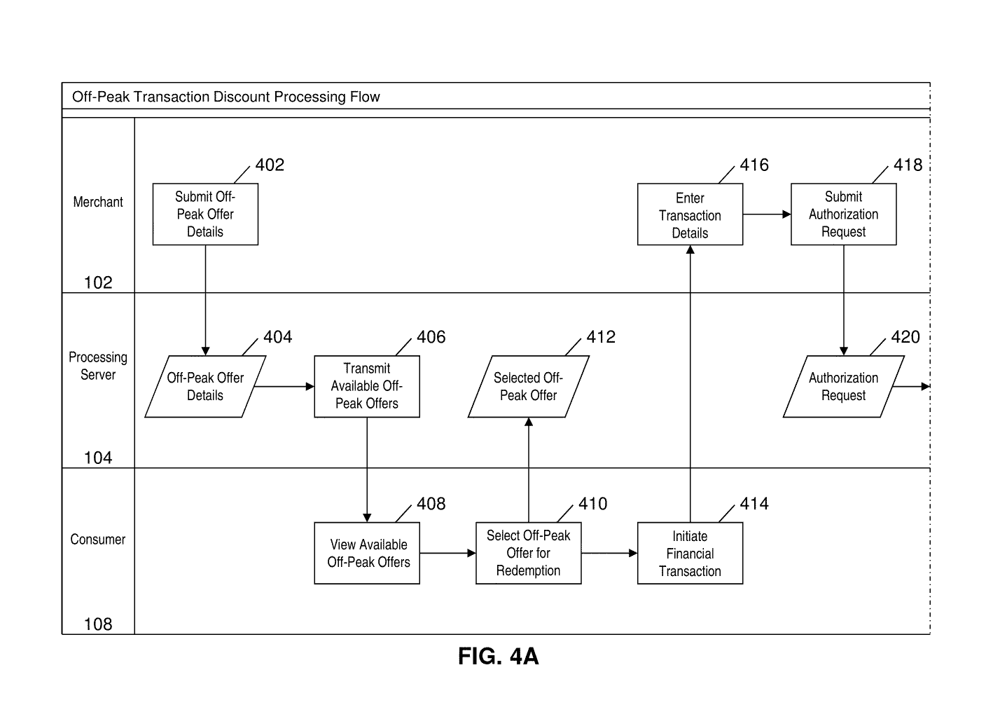

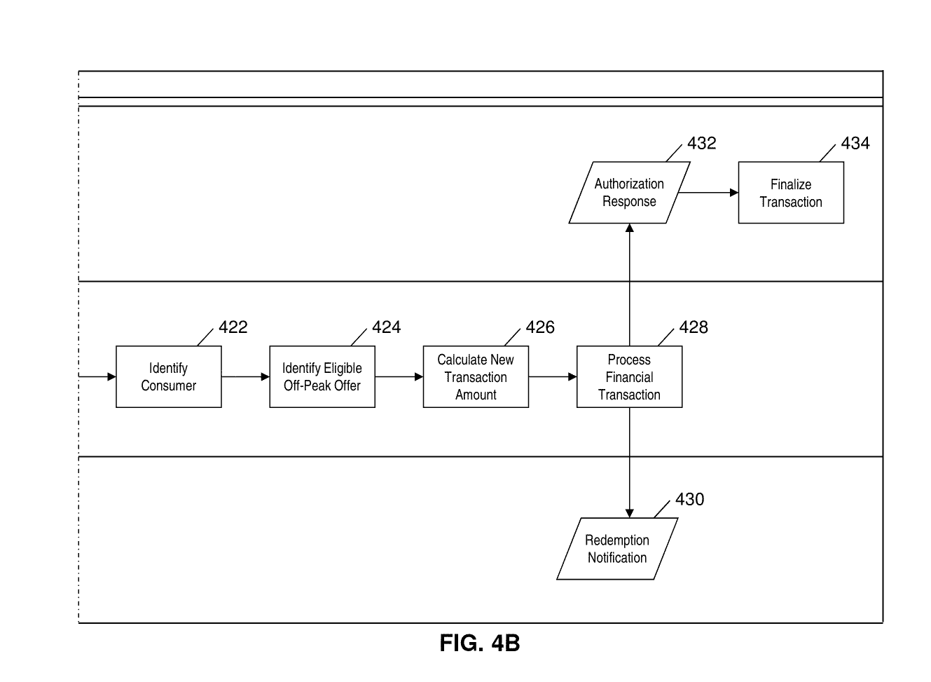

FIGS. 4A and 4B are a processing flow illustrating a process for the creation of discounts, selection of discounts, and processing of a discount for an off-peak transaction.

In step 402, the merchant 102 may submit details for an off-peak offer to the processing server 104 (e.g., via a webpage). In step 404, the processing server 104 may receive (e.g., via the receiving unit 202) the off-peak offer details, which may include at least the start time 308, the end time 310, and the transaction modifier 312. The processing server 104 may store the offer details in an offer data entry 302 in the offer database 106. In some embodiments, the offer details may include the offer identifier 304 and/or the merchant identifier 306. In other embodiments, the processing server 104 may identify the offer identifier 304 and/or the merchant identifier 306 to be included in the corresponding offer data entry 302.

In step 406, the processing server 104 may transmit available off-peak offers to the consumer 108 (e.g., via a webpage or an application program, such as executed by the consumer device 110). In one embodiment, offers may be transmitted to the consumer 108 based on consumer preferences (e.g., stored in a corresponding consumer data entry in the consumer database 112) or by criteria indicated by the consumer 108 in a request for available offers. For example, the consumer 108 may have enrolled in a discount program with the processing server 104, during which the consumer 108 may have provided consumer preferences or other information to facilitate the receipt of offers. In some instances, the processing server 104 may transmit (e.g., push) available off-peak offers to the consumer 108 without explicit instruction from the consumer 108, such as alerting the consumer 108 to a new available off-peak offer as it is received by the processing server 104.

In step 408, the consumer 108 may receive the available off-peak offers and may view them (e.g., via the consumer device 110). In step 410, the consumer 108 may select an off-peak offer for redemption, such as by indicating using the consumer device 110 an offer to be redeemed.

In step 412, the processing server 104 may receive the indication of the selected off-peak offer, and may update the consumer database 112 and/or the offer database 106 to indicate that the related offer is to be redeemed by the consumer 108 as part of the next eligible transaction. In step 414, the consumer 108 may initiate a financial transaction with the merchant 102. Initiating the financial transaction may include identifying products or services to be purchased and providing payment information to the merchant 102, such as a payment card. In step 416, the merchant 102 may enter transaction details including the payment information into a point-of-sale device. In step 418, the merchant 102 may submit an authorization request for the financial transaction to the processing server 104.

In step 420, the processing server 104 may receive the authorization request, which may include at least a transaction amount, a transaction time, a merchant identifier 306, and a consumer identifier (e.g., the payment card number corresponding to the payment card used to fund the transaction). In step 422, the processing server 104 may identify the consumer 108 based on the consumer identifier, such as by identifying the consumer data entry included in the consumer database 112 related to the consumer 108. In step 424, the processing server 104 may identify an eligible off-peak offer to be applied to the transaction. Identifying an eligible off-peak offer may include identifying, in the offer database 106, an offer data entry 302 where the merchant identifier 306 is included in the authorization request, where the corresponding offer identifier 304 is associated with the identified consumer data entry, and where the transaction time is within the start time 308 and the end time 310 (e.g., and where the date of the transaction corresponds to date data included in the offer data entry 302 when applicable).

In some embodiments, identifying an eligible off-peak offer may further include identifying a time zone where the transaction is taking place and identifying eligible off-peak offers where the transaction time is within the start time 308 and end time 310 based on the identified time zone. In some instances, the start time 308 and end time 310 may be associated with a specific time zone (e.g., identified by the merchant 102 when creating the offer), or all start times 308 and end times 310 may be formatted with respect to a specific time zone (e.g., Greenwich Mean Time). It will be apparent to persons having skill in the relevant art that the time zone in which the transaction is taking place may be dependent on the type of transaction (e.g., physical, online, etc.) and, such as for Internet-based transactions, may be based on either the location of the consumer 108 or merchant 102, which in turn may be specified by the offer. For example, a merchant 102 may specify that a specific off-peak offer must be redeemed within the start time 308 and end time 310 based on the location of the consumer 108 at the time of the transaction, which may allow for consumers in different time zones to redeem the offer at different times relative to the merchant 102, but at the same time as relative to the individual consumers.

In step 426, the processing server 104 may (e.g., via the processing unit 204) calculate a new transaction amount for the financial transaction based on the transaction modifier 312 included in the identified eligible offer data entry 302. Methods for calculating a new transaction amount due to the redemption of an offer or discount will be apparent to persons having skill in the relevant art. In step 428, the processing server 104 may process the financial transaction for the new transaction amount using methods and systems as will be apparent to persons having skill in the relevant art, including the traditional four party financial transaction processing system. In step 430, the processing server 104 may transmit (e.g., via the transmitting unit 206) a notification of redemption to the consumer 108 (e.g., via the consumer device 110), notifying the consumer 108 of the redemption of the offer related to the identified offer data entry 302.

In step 432, the processing server 104 may transmit an authorization response to the merchant 102 indicating the approval of the financial transaction for the new transaction amount. In an exemplary embodiment, the authorization response may be indicated as being for a final authorization rather than a partial authorization. In a further embodiment, the authorization response may include an indication to be included on a receipt to reflect the redemption of the offer. In step 434, the merchant 102 may finalize the transaction, such as by furnishing a receipt to the consumer 108 for the transacted goods or services.

In an alternative embodiment, in step 426, the processing server 104 may calculate a chargeback amount based on the transaction modifier 312 such that the financial transaction may be processed in step 428 for the original transaction amount included in the authorization request. The processing server 104 may then process a chargeback for the calculated chargeback amount, which may be leveraged on the merchant 102 and credit the financial account of the consumer 108 used to fund the financial transaction.

### Graphical User Interfaces for Adding and Selecting Off-Peak Offers

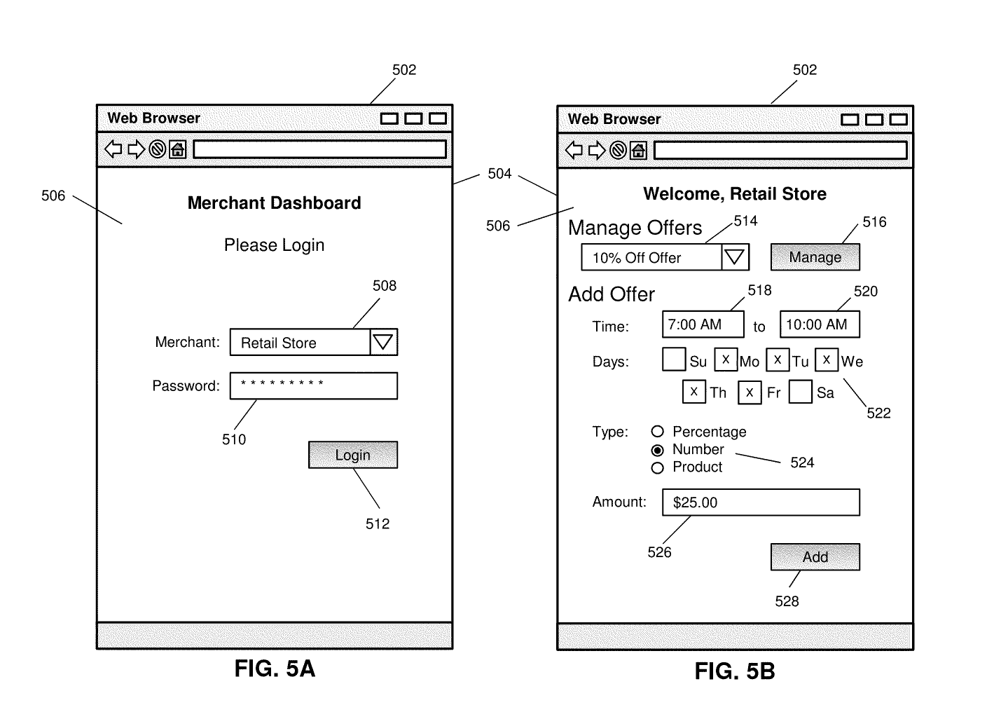

FIGS. 5A and 5B illustrate a graphical user interface for the merchant 102 for the submitting of offer information for off-peak offers to be included in the offer database 106 of the processing server 104.

As illustrated in FIG. 5A, the merchant 102 may navigate to a webpage 504 using a web browser 502 or other application program configured to view webpages. The webpage 504 may be hosted by the processing server 104 or a web hosting server operated by or on behalf of the processing server 104. The webpage 504 may display a merchant dashboard 506. The merchant dashboard 506 may display a login to authenticate the merchant 102.

The login may include a merchant field 508. The merchant field 508 may be an input field that may require the merchant 102 to input a username or other type of information to identify the merchant (e.g., the merchant identifier 306), or may be a selection box (e.g., a drop-down box) as illustrated in FIG. 5A where the merchant 102 may select themselves from the box. The login may also include a password field 510, where the merchant 102 may input a password to authenticate themselves as the merchant indicated in the merchant field 508.

The merchant dashboard 506 may also include a login button 512. When the user (e.g., the merchant 102) interacts with the login button 512, the provided authentication information may be transmitted to the processing server 104. The processing server 104 may identify the merchant 102 based on the provided authentication information. The merchant 102 may then be presented with a merchant dashboard 506 on the webpage 504 as illustrated in FIG. 5B.

The merchant dashboard 506 of FIG. 5B may include an offer selection 514, which may be a selection box of all offers related to offer data entries 302 in the offer database 106 for which the merchant 102 corresponds to the included merchant identifier 306. The merchant 102 may select an offer, then interact with a manage button 516, which may present the merchant 102 with a different screen of the merchant dashboard 506 to manage the existing offer. In some embodiments, the screen may be similar to that for adding an offer in the merchant dashboard 506 of FIG. 5B.

The merchant dashboard 506 illustrated in FIG. 5B may also include an add offer section, which may include a start time field 518 and an end time field 520, where the merchant 102 may input the start and end times during which an off-peak offer may be valid. The merchant dashboard 506 may also include day selections 522, which may include a checkbox for each day of the week. The merchant 102 may activate a checkbox for a day to indicate that the offer may be valid during the specified start and end times for that day of the week. As illustrated in FIG. 5B, the offer being added by the merchant 102 may be valid between 7:00 AM and 10:00 AM on weekdays.

The merchant dashboard 506 may also include an offer type selection 524, which may include a plurality of radio buttons corresponding to various types of offers. As illustrated, the offer type selection 524 may include a percentage offer (e.g., 10% off, 25% off, etc.), a number offer ($10 off, $25 off, etc.), or a product offer (e.g., Buy one get one free for a specific product). Additional offer types that may be included will be apparent to persons having skill in the relevant art. The merchant dashboard 506 may also include an amount field 526, which the merchant 102 may fill out to indicate the value for the corresponding offer type. In the illustrated example, the merchant 102 has selected a number type offer with a value of $25.00, corresponding to an offer for $25.00 off. In some embodiments, the amount field 526 may automatically change to a corresponding field when the offer selection 524 is modified by the merchant 102.

The merchant 102 may interact with an add button 528, which may cause the processing server 104 to add a new offer data entry 302 related to the offer into the offer database 106, where the start time field 518 may corresponding to the start time 308, the end time field 520 may correspond to the end time 310, and the transaction modifier 312 may be based on the offer selection 524 and the offer amount 526. The merchant identifier 306 may be identified by the processing server 104 based on the authentication information provided by the merchant 102 in order to log in to the merchant dashboard 506.

In embodiments where each offer data entry 302 may include additional information (e.g., offer name, minimum transaction amount, etc.), the merchant dashboard 506 may include additional fields corresponding to the additional information. For example, the merchant 102 may indicate via the merchant dashboard 506 that the new offer may be available only for those transactions conducted in person (e.g., at a physical location of the merchant 102) or remotely (e.g., via telephone, mail, the Internet, etc.). In other instances, the merchant dashboard 506 may include time zone information (e.g., corresponding to the start time field 518 and/or end time field 520) and/or the ability to select if the transaction time is to be based on the consumer 108 or the merchant 102, such as a radio button selection. In some cases, the selection for the basis of the transaction time may only be available if the merchant 102 indicates that transactions may be conducted remotely (e.g., not in-person).

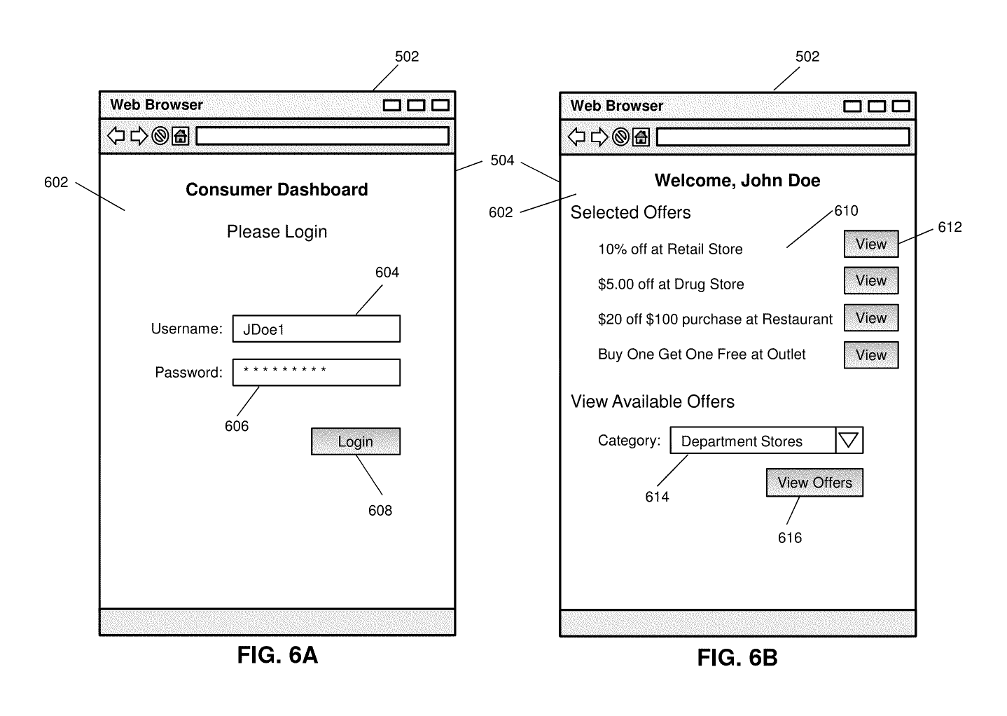

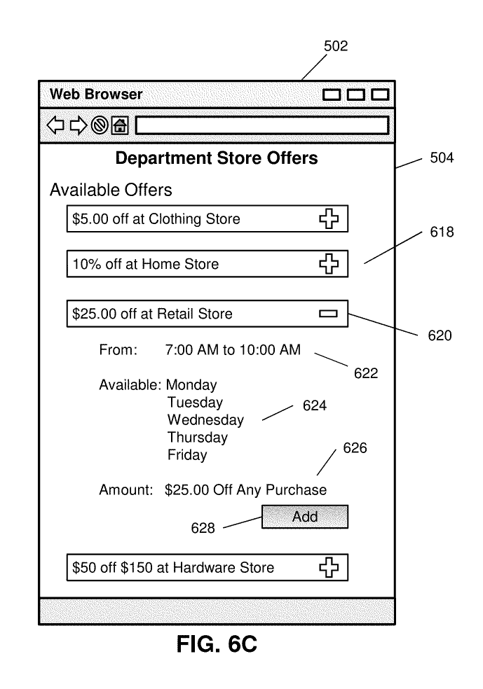

FIGS. 6A-6C illustrate a graphical user interface for the selection of off-peak offers by the consumer 108 using the consumer device 110. The consumer 102 may use an application program on the consumer device 110 including a web browser 502 to navigate to a webpage 504. The webpage 504 may display a consumer dashboard 602. In FIG. 6A, the consumer dashboard 602 may display login information to the consumer 108. The login may include a username field 604 and a password field 606, which may be used to authenticate the consumer 108. The consumer 108 may fill out both fields and then interact with a login button 508. Once the login button 508 is pressed, the processing server 104 may identify a consumer data entry related to the consumer 108 in the consumer database 112 based on the provided authentication information.

The consumer 108 may then be presented with the consumer dashboard 602 as illustrated in FIG. 6B. The consumer dashboard 602 may display a list of selected offers 610, which may display each offer that the consumer 108 has previously selected in order to redeem. Each selected offer in the list of selected offers 610 may include a view button 612. When the consumer 108 interacts with the view button 612 for a previously selected offer, the consumer 108 may be presented with a display detailing the information regarding the offer (e.g., as stored in the related offer data entry 302 in the offer database 106).

The consumer dashboard 602 may further include a category selection 614, which may enable the consumer 108 to select from a plurality of merchant categories from which to view offers. Merchant categories may be based on name, industry, location, etc. as will be apparent to persons having skill in the relevant art. In some embodiment, offers may be viewed based on alternative or additional criteria which may include offer name, offer amount, offer type, etc. The consumer 108 may select a category using the category selection 614 and then interact with a view offers button 616. The processing server 104 may receive the selected category and then may identify corresponding offer data entries 302 in the offer database 106 (e.g., based on an additional offer category field that may be included in each offer data entry 302 as necessary).

As illustrated in FIG. 6C, once the consumer 108 selects a category using the category selection 614, the consumer 108 may be presented with a list of available offers 618. The consumer 108 may select from a specific offer, such as the offer 620, which may cause the webpage 504 to display detailed information regarding that offer. The detailed information for the offer 620 may include the start and end time 622 for the offer, available days 624 that indicate what days of the week the offer is valid for, and a transaction modifier 626, which may indicate the value of the offer. It will be apparent to persons having skill in the relevant art that the offer details may include additional information as necessary (e.g., based on data included in the related offer data entry 302), such as time zone information, quantity information, additional limitations on redemption, etc.

The offer details may also include an add button 628. The add button 628, when interacted with by the consumer 108, may cause the processing server 104 to associate the offer 620 with the consumer 108 (e.g., in the consumer database 112 and/or the offer database 106). The offer 620 may then be viewable by the consumer 108 in the list of selected offers 610, and may be applied to eligible financial transactions involving the consumer 108 based on the specified start and end time 622 and available days 624.

### First Exemplary Method for Processing a Discount for an Off-Peak Transaction

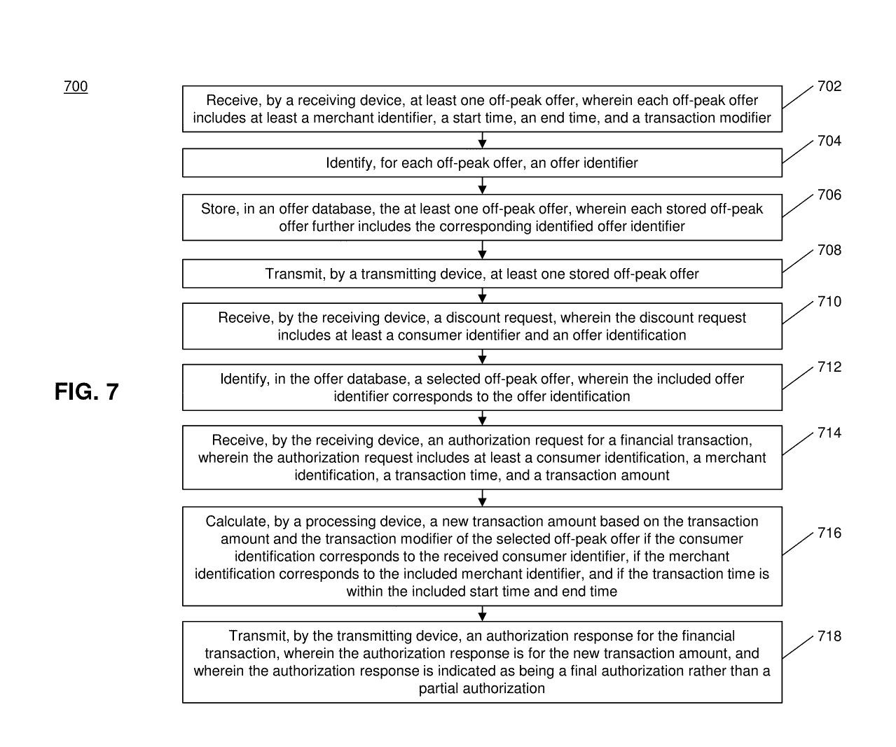

FIG. 7 illustrates a method 700 for processing a discount for an off-peak transaction.

In step 702, at least one off-peak offer may be received by a receiving device (e.g., the receiving unit 202), wherein each off-peak offer includes at least a merchant identifier (e.g., the merchant identifier 306), a start time (e.g., the start time 308), an end time (e.g., the end time 310), and a transaction modifier (e.g., the transaction modifier 312). In one embodiment, each off-peak offer may further include at least one of: an expiration date, a quantity, an offer name, an offer category, an offer description, a minimum transaction amount, terms and conditions, and a limitation on redemption.

In step 704, an offer identifier (e.g., the offer identifier 304) may be identified for each off-peak offer. In step 706, the at least one off-peak offer may be stored in an offer database (e.g., the offer database 106), wherein each stored off-peak offer further includes the corresponding identified offer identifier 304.

In step 708, at least one stored off-peak offer may be transmitted, by a transmitting device (e.g., the transmitting unit 206). In one embodiment, each off-peak offer may further include at least a merchant category, and transmitting the at least one stored off-peak offer may include transmitting at least one off-peak offer including a specific merchant category in response to a receiving a request for off-peak offers, the request including the specific merchant category.

In step 710, a discount request may be received by the receiving device 202, wherein the discount request includes at least a consumer identifier and an offer identification. In on embodiment, the consumer identifier may be a payment card number of financial account number. In step 712, a selected off-peak offer may be identified in the offer database 106, wherein the included offer identifier 304 corresponds to the offer identification. In step 714, an authorization request for a financial transaction may be received, wherein the authorization request includes at least a consumer identification, a merchant identification, a transaction time, and a transaction amount.

In step 716, a processing device (e.g., the processing unit 204), may calculate a new transaction amount based on the transaction amount and the transaction modifier 312 of the selected off-peak offer if the consumer identification corresponds to the received consumer identifier, if the merchant identification corresponds to the included merchant identifier 306, and if the transaction time is within the included start time 308 and end time 310. In step 718, an authorization response for the financial transaction may be transmitting, by the transmitting device 206, wherein the authorization response is for the new transaction amount, and wherein the authorization response is indicated as being a final authorization rather than a partial authorization. In one embodiment, the authorization response may include an indication that the selected off-peak offer was applied to the financial transaction.

### Second Exemplary Method for Processing a Discount for an Off-Peak Transaction

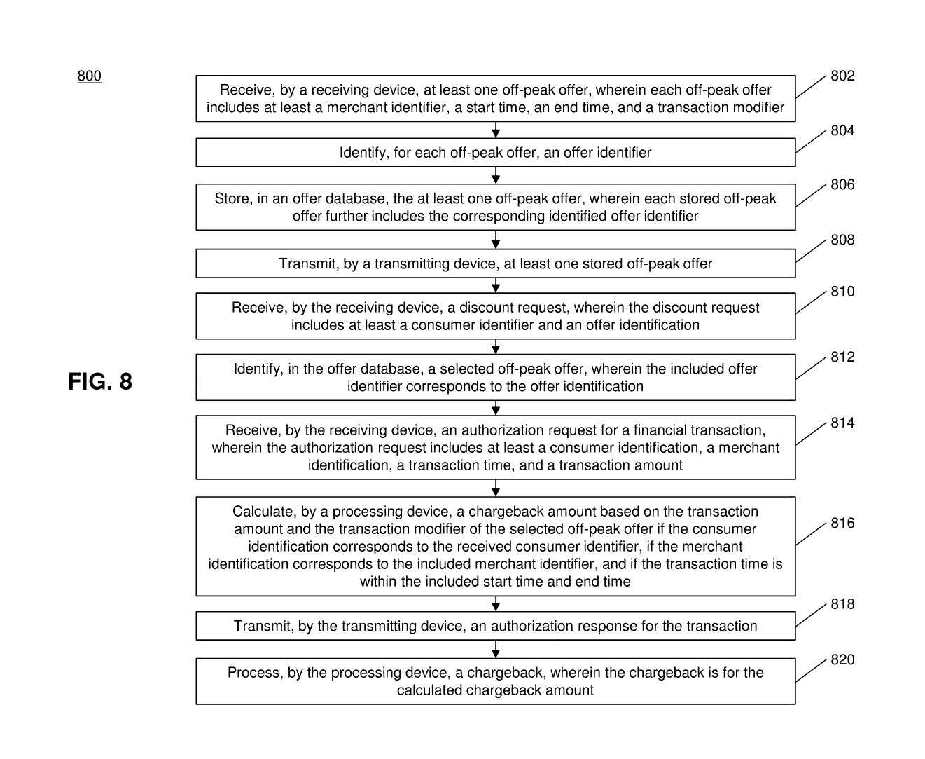

FIG. 8 illustrates a method 800 for processing a discount for an off-peak transaction.

In step 802, at least one off-peak offer may be received by a receiving device (e.g., the receiving unit 202), wherein each off-peak offer includes at least a merchant identifier (e.g., the merchant identifier 306), a start time (e.g., the start time 308), an end time (e.g., the end time 310), and a transaction modifier (e.g., the transaction modifier 312). In one embodiment, each off-peak offer may further include at least one of: an expiration date, a quantity, an offer name, an offer category, an offer description, a minimum transaction amount, terms and conditions, and a limitation on redemption. In step 804, an offer identifier (e.g., the offer identifier 304) may be identified for each off-peak offer.

In step 806, the at least one off-peak offer may be stored in an offer database (e.g., the offer database 106), wherein each stored off-peak offer further includes the corresponding identified offer identifier 304. In step 808, at least one stored off-peak offer may be transmitted, by a transmitting device (e.g., the transmitting unit 206). In one embodiment, each off-peak offer may further include a merchant category, and transmitting at least one stored off-peak offer may include transmitting at least one stored off-peak offer including a specific merchant category in response to receiving a request for off-peak offers, the request including the specific merchant category.

In step 810, a discount request may be received by the receiving device 202, wherein the discount request includes at least a consumer identifier and an offer identification. In one embodiment, the consumer identifier may be a payment card number of a financial account number. In step 812, a selected off-peak offer may be identified in the offer database 106, wherein the included offer identifier 304 corresponds to the offer identification. In step 814, an authorization request for a financial transaction may be received by the receiving unit 202, wherein the authorization request includes at least a consumer identification, a merchant identification, a transaction time, and a transaction amount.

In step 816, a processing device (e.g., the processing unit 204) may calculate a chargeback amount based on the transaction amount if the transaction modifier 312 of the selected off-peak offer if the consumer identification corresponds to the receiving consumer identifier, If the merchant identification corresponds to the included merchant identifier 306, and if the transaction time is included within the start time 308 and the end time 310.

In step 818, an authorization response for the financial transaction may be transmitted by the transmitting device 206. In step 820, a chargeback may be processed, by the processing device 204, wherein the chargeback is for the calculated chargeback amount.

### Computer System Architecture

FIG. 9 illustrates a computer system 900 in which embodiments of the present disclosure, or portions thereof, may be implemented as computer-readable code. For example, the consumer device 110, the processing server 104, and the merchant 102 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A, 4B, 7, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communication infrastructure 906, such as a bus, message queue, network (e.g., the network 114), multi-core message-passing scheme, etc. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive, the removable storage unit 918 may be a floppy disk. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 910, which may be memory semiconductors (e.g. DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 804 to implement the methods illustrated by FIGS. 4A, 4B, 7, and 8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for the processing of discounts for off-peak transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a discount for an off-peak transaction, comprising:
receiving, by a receiving device, at least one off-peak offer, wherein each off-peak offer includes at least a merchant identifier, a start time, an end time, and a transaction modifier;
identifying, for each off-peak offer, an offer identifier;
storing, in an offer database, the at least one off-peak offer, wherein each stored off-peak offer further includes the corresponding identified offer identifier;
transmitting, by a transmitting device, at least one stored off-peak offer;
receiving, by the receiving device, a discount request, wherein the discount request includes at least a consumer identifier and an offer identification;
identifying, in the offer database, a selected off-peak offer, wherein the included offer identifier corresponds to the offer identification;
receiving, by the receiving device, an authorization request for a financial transaction, wherein the authorization request includes at least a consumer identification, a merchant identification, a transaction time, and a transaction amount;
calculating, by a processing device, a new transaction amount based on the transaction amount and the transaction modifier for the selected off-peak offer if the consumer identification corresponds to the received consumer identifier, if the merchant identification corresponds to the included merchant identifier, and if the transaction time is within the included start time and end time; and
transmitting, by the transmitting device, an authorization response for the financial transaction, wherein the authorization response is for the new transaction amount, and wherein the authorization response is indicated as being a final authorization rather than a partial authorization.

2. The method of claim 1, wherein
each off-peak offer further includes at least a merchant category, and
transmitting at least one stored off-peak offer includes transmitting at least one stored off-peak offer including a specific merchant category in response to receiving a request for off-peak offers, the request including the specific merchant category.

3. The method of claim 1, wherein each off-peak offer further includes at least one of: an expiration date, a quantity, an offer name, an offer category, an offer description, a minimum transaction amount, terms and conditions, and a limitation on redemption.

4. The method of claim 1, wherein the consumer identifier is a payment card number.

5. The method of claim 1, wherein the authorization response includes an indication that the selected off-peak offer was applied.

6. A method for processing a discount for an off-peak transaction, comprising:
receiving, by a receiving device, at least one off-peak offer, wherein each off-peak offer includes at least a merchant identifier, a start time, an end time, and a transaction modifier;
identifying, for each off-peak offer, an offer identifier;
storing, in an offer database, the at least one off-peak offer, wherein each stored off-peak offer further includes the corresponding identified offer identifier;
transmitting, by a transmitting device, at least one stored off-peak offer;
receiving, by the receiving device, a discount request, wherein the discount request includes at least a consumer identifier and an offer identification;
identifying, in the offer database, a selected off-peak offer, wherein the included offer identifier corresponds to the offer identification;
receiving, by the receiving device, an authorization request for a financial transaction, wherein the authorization request includes at least a consumer identification, a merchant identification, a transaction time, and a transaction amount;
calculating, by a processing device, a chargeback amount based on the transaction amount and the transaction modifier for the selected off-peak offer if the consumer identification corresponds to the received consumer identifier, if the merchant identification corresponds to the included merchant identifier, and if the transaction time is within the included start time and end time;
transmitting, by the transmitting device, an authorization response for the financial transaction; and
processing, by the processing device, a chargeback, wherein the chargeback is for the calculated chargeback amount.

7. The method of claim 6, wherein
each off-peak offer further includes at least a merchant category, and
transmitting at least one stored off-peak offer includes transmitting at least one stored off-peak offer including a specific merchant category in response to receiving a request for off-peak offers, the request including the specific merchant category.

8. The method of claim 6, wherein each off-peak offer further includes at least one of: an expiration date, a quantity, an offer name, an offer category, an offer description, a minimum transaction amount, terms and conditions, and a limitation on redemption.

9. The method of claim 6, wherein the consumer identifier is a payment card number.

10. A system for processing a discount for an off-peak transaction, comprising:
a receiving device configured to receive at least one off-peak offer, wherein each off-peak offer includes at least a merchant identifier, a start time, an end time, and a transaction modifier;
a processing device configured to identify, for each off-peak offer, an offer identifier;
an offer database configured to store the at least one off-peak offer and the corresponding identified offer identifier; and
a transmitting device configured to transmit at least one stored off-peak offer, wherein
the receiving device is further configured to receive a discount request, the discount request including at least a consumer identifier and an offer identification,
the processing device is further configured to identify, in the offer database, a selected off-peak offer, the included offer identifier corresponding to the offer identification,
the receiving device is further configured to receive an authorization request for a financial transaction, the authorization request including at least a consumer identification, a merchant identification, a transaction time, and a transaction amount,
the processing device is further configured to calculate a new transaction amount based on the transaction amount and the transaction modifier for the selected off-peak offer if the consumer identification corresponds to the received consumer identifier, if the merchant identification corresponds to the included merchant identifier, and if the transaction time is within the included start time and end time, and
the transmitting device is further configured to transmit an authorization response for the financial transaction, the authorization response being for the new transaction amount and indicated as being a final authorization rather than a partial authorization.

11. The system of claim 10, wherein
each off-peak offer further includes at least a merchant category, and
transmitting at least one stored off-peak offer includes transmitting at least one stored off-peak offer including a specific merchant category in response to receiving a request for off-peak offers, the request including the specific merchant category.

12. The system of claim 10, wherein each off-peak offer further includes at least one of: an expiration date, a quantity, an offer name, an offer category, an offer description, a minimum transaction amount, terms and conditions, and a limitation on redemption.

13. The system of claim 10, wherein the consumer identifier is a payment card number.

14. The system of claim 10, wherein the authorization response includes an indication that the selected off-peak offer was applied.

15. A processing device configured to process a discount for an off-peak transaction, wherein the processing device is configured to:
identify, for at least one off-peak offer, an offer identifier, wherein each of the at least one off-peak offer includes at least a merchant identifier, a start time, an end time, and a transaction modifier;
store, in a database, the at least one off-peak offer and corresponding offer identifier;
identify, in the database, a selected off-peak offer based on an offer identifier included in a discount request; and
calculate a new transaction amount for a financial transaction based on a transaction amount included in an authorization request for the financial transaction and the transaction modifier of the selected off-peak offer, wherein the authorization request further includes at least the merchant identifier and a transaction time included within the start time and end time of the selected off-peak offer.

16. The processing device of claim 15, wherein each of the at least one off-peak offer further includes at least one of: an expiration date, a quantity, an offer name, an offer category, an offer description, a minimum transaction amount, terms and conditions, and a limitation on redemption.

17. A receiving device for use in processing a discount for an off-peak transaction, wherein the receiving device is configured to:
receive at least one off-peak offer, wherein each of the at least one off-peak offer includes at least a merchant identifier, a start time, an end time, and a transaction modifier;
receive a discount request for use in identifying a selected off-peak offer, wherein the discount request includes at least a consumer identifier and an offer identifier used to identify the selected off-peak offer; and
receive an authorization request for a financial transaction, wherein the authorization request includes at least a consumer identification, a merchant identification, a transaction time, and a transaction amount,
wherein the transaction amount is used to calculate a new transaction amount based on the transaction modifier of the selected off-peak offer if the consumer identification corresponds to the consumer identifier, if the merchant identification corresponds to the merchant identifier, and the transaction time is within the included start time and end time.

18. The receiving device of claim 17, wherein each of the at least one off-peak offer further includes at least one of: an expiration date, a quantity, an offer name, an offer category, an offer description, a minimum transaction amount, terms and conditions, and a limitation on redemption.

19. The receiving device of claim 17, wherein the consumer identifier is a payment card number.

20. A non-transitory computer readable recording medium having program code stored therein that causes a processor of a computing device to execute the following steps:
receiving, by a receiving device, at least one off-peak offer, wherein each off-peak offer includes at least a merchant identifier, a start time, an end time, and a transaction modifier;
identifying, for each off-peak offer, an offer identifier;
storing, in an offer database, the at least one off-peak offer, wherein each stored off-peak offer further includes the corresponding identified offer identifier;
transmitting, by a transmitting device, at least one stored off-peak offer;
receiving, by the receiving device, a discount request, wherein the discount request includes at least a consumer identifier and an offer identification;
identifying, in the offer database, a selected off-peak offer, wherein the included offer identifier corresponds to the offer identification;
receiving, by the receiving device, an authorization request for a financial transaction, wherein the authorization request includes at least a consumer identification, a merchant identification, a transaction time, and a transaction amount;
calculating, by a processing device, a new transaction amount based on the transaction amount and the transaction modifier for the selected off-peak offer if the consumer identification corresponds to the received consumer identifier, if the merchant identification corresponds to the included merchant identifier, and if the transaction time is within the included start time and end time; and
transmitting, by the transmitting device, an authorization response for the financial transaction, wherein the authorization response is for the new transaction amount, and wherein the authorization response is indicated as being a final authorization rather than a partial authorization.

21. A system for processing a discount for an off-peak transaction, comprising:
a receiving device configured to receive at least one off-peak offer, wherein each off-peak offer includes at least a merchant identifier, a start time, an end time, and a transaction modifier;
a processing device configured to identify, for each off-peak offer, an offer identifier;
an offer database configured to store the at least one off-peak offer and the corresponding identified offer identifier; and
a transmitting device configured to transmit at least one stored off-peak offer, wherein
the receiving device is further configured to receive a discount request, the discount request including at least a consumer identifier and an offer identification,
the processing device is further configured to identify, in the offer database, a selected off-peak offer, the included offer identifier corresponding to the offer identification,
the receiving device is further configured to receive an authorization request for a financial transaction, the authorization request including at least a consumer identification, a merchant identification, a transaction time, and a transaction amount,
the processing device is further configured to calculate a chargeback amount based on the transaction amount and the transaction modifier for the selected off-peak offer if the consumer identification corresponds to the received consumer identifier, if the merchant identification corresponds to the included merchant identifier, and if the transaction time is within the included start time and end time,
the transmitting device is further configured to transmit an authorization response for the financial transaction, and
the processing device is further configured to process a chargeback, wherein the chargeback is for the calculated chargeback amount.

22. The system of claim 21, wherein
each off-peak offer further includes at least a merchant category, and
transmitting at least one stored off-peak offer includes transmitting at least one stored off-peak offer including a specific merchant category in response to receiving a request for off-peak offers, the request including the specific merchant category.

23. The system of claim 21, wherein each off-peak offer further includes at least one of: an expiration date, a quantity, an offer name, an offer category, an offer description, a minimum transaction amount, terms and conditions, and a limitation on redemption.

24. The system of claim 21, wherein the consumer identifier is a payment card number.

25. A processing device configured to process a discount for an off-peak transaction, wherein the processing device is configured to:
identify, for at least one off-peak offer, an offer identifier, wherein each of the at least one off-peak offer includes at least a merchant identifier, a start time, an end time, and a transaction modifier;
store, in a database, the at least one off-peak offer and corresponding offer identifier;
identify, in the database, a selected off-peak offer based on an offer identifier included in a discount request;
calculate a chargeback amount for a financial transaction based on a transaction amount included in an authorization request for the financial transaction and the transaction modifier of the selected off-peak offer, wherein the authorization request further includes at least the merchant identifier and a transaction time included within the start time and end time of the selected off-peak offer; and
process a chargeback, wherein the chargeback is for the calculated chargeback amount.

26. The processing device of claim 25, wherein each of the at least one off-peak offer further includes at least one of: an expiration date, a quantity, an offer name, an offer category, an offer description, a minimum transaction amount, terms and conditions, and a limitation on redemption.

27. A receiving device for use in processing a discount for an off-peak transaction, wherein the receiving device is configured to:
receive at least one off-peak offer, wherein each of the at least one off-peak offer includes at least a merchant identifier, a start time, an end time, and a transaction modifier;
receive a discount request for use in identifying a selected off-peak offer, wherein the discount request includes at least a consumer identifier and an offer identifier used to identify the selected off-peak offer; and
receive an authorization request for a financial transaction, wherein the authorization request includes at least a consumer identification, a merchant identification, a transaction time, and a transaction amount,
wherein the transaction amount is used to calculate a chargeback amount based on the transaction modifier of the selected off-peak offer if the consumer identification corresponds to the consumer identifier, if the merchant identification corresponds to the merchant identifier, and the transaction time is within the included start time and end time.

28. The receiving device of claim 27, wherein each of the at least one off-peak offer further includes at least one of: an expiration date, a quantity, an offer name, an offer category, an offer description, a minimum transaction amount, terms and conditions, and a limitation on redemption.

29. The receiving device of claim 27, wherein the consumer identifier is a payment card number.

30. A non-transitory computer readable recording medium having program code stored therein that causes a processor of a computing device to execute the following steps:
receiving, by a receiving device, at least one off-peak offer, wherein each off-peak offer includes at least a merchant identifier, a start time, an end time, and a transaction modifier;
identifying, for each off-peak offer, an offer identifier;
storing, in an offer database, the at least one off-peak offer, wherein each stored off-peak offer further includes the corresponding identified offer identifier;
transmitting, by a transmitting device, at least one stored off-peak offer;
receiving, by the receiving device, a discount request, wherein the discount request includes at least a consumer identifier and an offer identification;
identifying, in the offer database, a selected off-peak offer, wherein the included offer identifier corresponds to the offer identification;
receiving, by the receiving device, an authorization request for a financial transaction, wherein the authorization request includes at least a consumer identification, a merchant identification, a transaction time, and a transaction amount;
calculating, by a processing device, a chargeback amount based on the transaction amount and the transaction modifier for the selected off-peak offer if the consumer identification corresponds to the received consumer identifier, if the merchant identification corresponds to the included merchant identifier, and if the transaction time is within the included start time and end time;
transmitting, by the transmitting device, an authorization response for the financial transaction; and
processing, by the processing device, a chargeback, wherein the chargeback is for the calculated chargeback amount.
